(19) United States
(12) Patent Application Publication
(10) Pub. No.: US 2013/0206687 A1
(43) Pub. Date: Aug. 15, 2013

(54) METHOD FOR USING ACTIVATED CARBON FOR TREATING WATER

(71) Applicants: Sidney A. Dunn, Lake Charles, LA (US); Roy Hernandez-Mena, The Woodlands, TX (US); Leonard E. Walther, Russellville, TX (US)

(72) Inventors: Sidney A. Dunn, Lake Charles, LA (US); Roy Hernandez-Mena, The Woodlands, TX (US); Leonard E. Walther, Russellville, TX (US)

(73) Assignee: BAKER HUGHES INCORPORATED, HOUSTON, TX (US)

(21) Appl. No.: 13/589,836

(22) Filed: Aug. 20, 2012

Related U.S. Application Data
(60) Provisional application No. 61/526,156, filed on Aug. 22, 2011.

(51) Int. Cl. C02F 3/10

(52) U.S. Cl. CPC C02F 3/106
USPC 210/631

(57) ABSTRACT

Waste water may be treated by introducing activated carbon into a biological oxidation system as a slurry wherein: (1) the slurry is stable as compared to a conventional activated carbon slurry; (2) the activated carbon within the slurry retains at least 85% of its absorptive capacity; and (3) the activated carbon is immediately available for absorbing organic compounds when introduced into the biological oxidation system. The method is particularly useful for treating upset conditions. These slurries may also be used for treating other types of water to remove compounds that can be absorbed by activated carbon. Exemplary of such water types are process water and run-off water.

### CROSS-REFERENCE TO RELATED APPLICATIONS

This application claims priority from U.S. Provisional Patent Application Ser. No.: 61/526,156, filed Aug. 22, 2011, the disclosure of which is incorporated herein by reference in its entirety.

### BACKGROUND OF THE INVENTION

1. Field of the Invention

This invention relates to treating water. This invention particularly relates to treating water with activated carbon.

2. Background of the Art

Activated carbon is known to be useful in the treatment of water. Activated carbon is a substance derived from coal, wood and other carbonaceous materials having great porosity, permeability and pore surface area. For reason of such great pore area, activated carbon is an excellent adsorbent from water of dissolved organic and some inorganic compounds. When such carbon affinitive compounds are considered contaminants to a water stream, the contaminations may be removed by merely flow contacting the water stream with a bed or slurry of activated carbon.

Activated carbon is particularly useful in applications where water is treated using a biological oxidation method. In one type of biological oxidation process, bacteria capable of oxidizing or otherwise decomposing contaminants in water are maintained in a reservoir and contaminated water is fed into the reservoir. Generally, the reservoir is maintained in a highly aerated state. The activated carbon acts both as a substrate for bacterial growth and as an adsorbent for surges in some kinds of contaminants. Another benefit of the use of activated biological oxidation units is that the activated carbon can promote the retention of bacteria within the reservoir.

The use of activated carbon is not always troubled free. For example, activated carbon does not always easily hydrate. This property can result in long delays between the time the activated carbon is added to a reservoir and the time that it begins to act as an absorbent. Once hydrated, activated carbon is often unstable as a dispersion. It is often impracticable to prepare and store activated carbon dispersions because they may settle and be difficult to feed or further handle. It would be desirable within the art to provide an activated carbon slurry that is storage stable and immediately effective as an absorbent when added to a reservoir of water. It would be especially desirable within the art in such a slurry retained all or nearly all of the absorptive capacity of the activated carbon used to make it.

### SUMMARY OF THE INVENTION

An aspect of the invention is a method for treating waste water including introducing activated carbon into a biological oxidation system as a slurry wherein: (1) the slurry is stable as compared to a conventional activated carbon slurry; (2) the activated carbon within the slurry retains at least 90% of its absorptive capacity; and (3) the activated carbon is immediately available for absorbing organic compounds when introduced into the biological oxidation system.

In another aspect, the invention is a method for preventing or mitigating the effects of an “upset” in a biological oxidation system including introducing activated carbon into a biological oxidation system as a slurry wherein: (1) the slurry is stable as compared to a conventional activated carbon slurry; (2) the activated carbon within the slurry retains at least 90% of its absorptive capacity; and (3) the activated carbon is immediately available for absorbing organic compounds when introduced into the biological oxidation system.

In still another aspect, the invention is a method for treating water to remove compounds that can be absorbed by activated carbon including admixing the water with an activated carbon slurry wherein: (1) the slurry is stable as compared to a conventional activated carbon slurry; (2) the activated carbon within the slurry retains at least 90% of its absorptive capacity; and (3) the activated carbon is immediately available for absorbing organic compounds when introduced.

### DETAILED DESCRIPTION OF THE PREFERRED EMBODIMENT

In one embodiment, the method of this application is a method for treating waste water including introducing activated carbon into a biological oxidation system as a slurry wherein: (1) the slurry is stable as compared to a conventional activated carbon slurry; (2) the activated carbon within the slurry retains at least 90% of its absorptive capacity; and (3) the activated carbon is immediately available for absorbing organic compounds when introduced into the biological oxidation system.

For the purposes of this application, the term “activated carbon” means a material consisting essentially of a porous carbon with a correspondingly low apparent density and substantial non-crystalline or amorphous phase. In most embodiments, the amorphous phase may form a continuous matrix with an apparent density of less than about 1.7 g/cm. In some embodiments the apparent density may be less than 1.5 g/cm. Apparent density means the mass per unit volume of a material including voids inherent in the material as tested. Activated carbon useful with the method of the invention may have a mesh size ranging from about 4-12 mesh to about 100 mesh. In some embodiments, a carbon product that is intermediate between activated carbon and graphite may be employed as long as it is functional in regard to either adsorbing organic or inorganic intermediates or can be advantageously employed as a substrate for bacterial growth.

Activated carbon useful with the method of the application can be manufactured by any technique known that to those of ordinary skill in the art including coking or extraction from coal and the so-called wood chars. Coke, an amorphous or poorly crystallized carbon may be derived from petroleum refinery products or coal. Chars are similar to coke but may be derived from wood, for example, coconut shell, walnut shell, pecan shell, hardwood, and softwood, and other cellulose-bearing stock. Unlike coke, chars do not pass through a fluid phase during pyrolysis and carbonization. Activated carbon can also be manufactured by carbonizing organic polymers, such as phenolic resins, and subsequently activating the carbon.

Also for the purposes of the present application, activated carbon may also include porous molecular sieve carbons, with poorly organized, disrupted, or imperfect lamellae structures, and with apparent densities less than graphite. Similarly, activated carbons may also include partially or fully carbonized carbonaceous materials such as woods, starches, polymers and petroleum refinery products.

For the purposes of the present application, the term “biological oxidation system” includes any system that treats waste water using biological components. Typically, these biological components are bacteria. In many such applications the bacteria either by natural selection or by design become specialized in oxidizing organic components routinely fed to the oxidation system.

In some embodiments of the method of the application, an activated carbon slurry is used to treat an upset condition. Such upsets often occur when there is a change in the composition of the feed stream to the biological oxidation system. This changing composition can be a change in the type of compounds being fed into the biological oxidation system or a change in the concentration of the compounds being fed into the biological oxidation system. For example, in a biological oxidation system which functions primarily to oxidize polyols, the introduction of thioesters might interfere with the ability of the bacteria within the system to oxidize polyols. Symptoms of such an upset may include an increase in the BOD (biological oxygen demand) in the effluent from the biological oxidation system; and an increase in the tendency of the bacteria to float on the surface of a clarifier.

In one embodiment of the method of the application, the activated carbon slurry would be introduced upstream of the biological oxidation system to absorb at least some of the undesirable components of the feed stream. In this embodiment, the impact of the upset in the feed stream can be mitigated, and in some embodiments even avoided entirely.

In another embodiment, where the upset condition in the feed stream to a biological oxidation system was observed too late to prevent the problematic feed from reaching the biological oxidation system, an activated carbon slurry can still be added to the biological oxidation system. Activated carbon, when introduced into such systems, often performs many functions. Exemplary of such functions are adsorbing organic materials, acting as a substrate for bacterial growth, promoting retention of bacteria within the treatment system, and the like. In this embodiment, the activated carbon in the slurry could adsorb enough of the undesirable compounds to mitigate the symptoms listed above and perhaps prevent having an effluent from the biological oxidation system that exceeds the limitations of the permit under which it is operated.

Conventional dispersions of the activated carbon are generally of two types. The first of these types is known as a mechanical dispersion. In a mechanical dispersion, activated carbon is introduced as a powder into water and then agitated until substantially all of the activated carbon is hydrated. Unfortunately, it is difficult to achieve this level of hydration with mechanical agitation alone. Also these dispersions tend to be very unstable. Upon storage, such dispersions often separate and then require nearly the same amount of agitation as did the original powdered activated carbon and water admixture. One advantage of mechanical dispersions is that the activated carbon retains all or nearly all of its absorptive capacity.

The second type of dispersion is one prepared using a dispersant. While there are dispersants and surfactants that can create a stable dispersion of activated carbon in water, these dispersants and surfactants can substantially reduce the absorptive capacity of the activated carbon.

Because both of these dispersions are undesirable in many applications, typically activated carbon is stored and used in powder form. Powdered activated carbon can be difficult to handle. When being introduced into water, the activated carbon powder can become airborne and become an inhalation hazard. Also, the powder takes a long time to hydrate, and thus is not immediately available to mitigate the effects of upsets in biological oxidation systems.

The method of this application may be used to treat water that is not within or a feed to a biological oxidation system. For example, the activated carbon slurries of this application may be employed to treat all kinds of water that are contaminated with components that can be absorbed by activated carbon. Exemplary of such water are process feed water, runoff water, cooling water, and the like. Any type of water subject to being contaminated with components that can be adsorbed by activated carbon may be treated using the method of this application.

The advantages of treating water with the slurries of this application are many. For example, the slurries used with the method of this application are immediately effective upon introduction into a contaminated body of water. Since the slurries are not subject to becoming inhalation hazards, they are also advantages over the use of activated carbon powders. Finally, since the activated carbon of the slurries retains all or nearly all of its absorptive capacity, less activated carbon is needed as compared to a conventional slurry prepared with conventional dispersants and surfactants.

The slurries used with the method of the application are more stable than mechanical slurries prepared using the same or substantially similar water and activated carbon powder. In one embodiment, upon standing in a 55 gallon drum undisturbed for 2 weeks, a slurry useful with the method of the application may have a packed density about ½ that of a conventional mechanical slurry.

The activated carbon within the slurries used with the method of application retain all or nearly all of their absorptive capacity. In one embodiment of the method of the application, the activated carbon retained all of its absorptive capacity as compared to the powdered activated carbon from which it was made. In another embodiment about 90% of the absorptive capacity was retained. In still another embodiment about 85% of the absorptive capacity was retained.

The activated carbon slurries useful with the method of the application are any having the properties of being stable as compared to a conventional activated carbon slurry; retaining at least 90% of the activated carbon's absorptive capacity; and the activated carbon is immediately available for absorbing organic compounds when introduced into the biological oxidation system or other type of water. The slurries may be prepared using any method but especially any method employing dispersants and/or surfactants that do not reduce or block the absorptive capacity of the activated carbon.

### EXAMPLES

The following example is provided to illustrate the invention. The example is not intended to limit the scope of the invention and they should not be so interpreted. Amounts are in weight parts or weight percentages unless otherwise indicated.

### Example

A sample of activated carbon having the trade designation WPX was obtained from the Calgon Carbon Corporation. The sample was tested using ASTM D-4607-97 which is titled STANDARD TEST METHOD FOR DETERMINATION OF ID NUMBER OF ACTIVATED CARBON. The iodine number of this material was 639. The same activated carbon was used by Solutions Dispersions of Cynthiana Kentucky to prepare a dispersion in water without the use of dispersants and/or surfactants which substantially reduce the absorptive capacity of the activated carbon. The dispersion was tested using ASTM D-4607-97 and had an iodine number of 698. This is retention of about 92% of its adsorptive capacity. The slurry appeared fully hydrated and was easily resuspended upon storage.

What is claimed is:

1. A method for treating waste water comprising introducing activated carbon into a biological oxidation system as a slurry wherein:
the slurry is stable as compared to a conventional activated carbon slurry;
the activated carbon within the slurry retains at least 85% of its absorptive capacity; and
the activated carbon is immediately available for absorbing organic compounds when introduced into the biological oxidation system.

2. The method of claim 1 wherein activated carbon used to prepare the slurry has an apparent density of less than about 1.7 g/cm.

3. The method of claim 2 wherein activated carbon used to prepare the slurry has an apparent density of less than about 1.5 g/cm.

4. The method of claim 1 wherein the activated carbon used to prepare the slurry has a mesh size ranging from about 4-12 mesh to about 100 mesh.

5. The method of claim 1 wherein the activated carbon within the slurry retains at least 90% of its absorptive capacity.

6. The method of claim 1 wherein the activated carbon slurry is introduced upstream of the biological system.

7. A method for preventing or mitigating the effects of an “upset” in a biological oxidation system comprising introducing activated carbon into a biological oxidation system as a slurry wherein:
the slurry is stable as compared to a conventional activated carbon slurry;
the activated carbon within the slurry retains at least 85% of its absorptive capacity; and
the activated carbon is immediately available for absorbing organic compounds when introduced into the biological oxidation system.

8. The method of claim 7 wherein activated carbon used to prepare the slurry has an apparent density of less than about 1.7 g/cm.

9. The method of claim 8 wherein activated carbon used to prepare the slurry has an apparent density of less than about 1.5 g/cm.

10. The method of claim 7 wherein the activated carbon used to prepare the slurry has a mesh size ranging from about 4-12 mesh to about 100 mesh.

11. The method of claim 7 wherein the activated carbon within the slurry retains at least 90% of its absorptive capacity.

12. The method of claim 7 wherein the activated carbon slurry is introduced upstream of the biological system.

13. A method for treating water to remove compounds that can be absorbed by activated carbon comprising admixing the water with an activated carbon slurry wherein:
the slurry is stable as compared to a conventional activated carbon slurry;
the activated carbon within the slurry retains at least 85% of its absorptive capacity; and
the activated carbon is immediately available for absorbing organic compounds when introduced into the water being treated.

14. The method of claim 13 wherein activated carbon used to prepare the slurry has an apparent density of less than about 1.7 g/cm.

15. The method of claim 14 wherein activated carbon used to prepare the slurry has an apparent density of less than about 1.5 g/cm.

16. The method of claim 13 wherein the activated carbon used to prepare the slurry has a mesh size ranging from about 4-12 mesh to about 100 mesh.

17. The method of claim 13 wherein the activated carbon within the slurry retains at least 90% of its absorptive capacity.

18. The method of claim 13 wherein the activated carbon slurry is introduced upstream of the biological system.
